(19) United States
(12) Patent Application Publication
(10) Pub. No.: US 2011/0296738 A1
(43) Pub. Date: Dec. 8, 2011

(54) FISHING LURE

(76) Inventor: Paul HOWE, Eagan, MN (US)

(21) Appl. No.: 13/154,042

(22) Filed: Jun. 6, 2011

Related U.S. Application Data
(60) Provisional application No. 61/351,618, filed on Jun. 4, 2010.

(51) Int. Cl. A01K 85/00; A01K 99/00

(52) U.S. Cl. 43/42.37; 43/42.53

(57) ABSTRACT

The fishing jig includes a plurality of head members, at least a connection region connecting head members adjacent thereto, at least a hook member having a hook shank, a bend connected to a first end of the hook shank and a point adjacent to the bend, and an eyelet. The hook shank is at least partially embedded in the connection region or embedded in a head member. The head members that are adjacent to the connection region are substantially symmetrical relative to the connection region.

### FIELD

This disclosure relates to a fishing lure for attachment to the end of a fishing line. The fishing lure is used to hook fish when the fish attack the lure. More specifically, this disclosure relates to a fishing lure commonly referred to as a fishing jig.

### BACKGROUND

In the sport of fishing, it is common to use an object or fishing lure attached to the end of a fishing line that catches the fish's attention so that the fish attacks and bites the object or fishing lure. The object or fishing lure contains a hook such that when the fish attacks the object, the hook is embedded in the fish and the fish can be caught.

One such conventional fishing lure is commonly referred to as a fishing jig. A conventional fishing jig consists of a lead sinker or single head with a hook molded into it. The head is located at the end opposite the sharp tip of the hook and an eyelet, for tying the fishing line, is located at the head end. The hook can be covered by a soft body or by live or artificial bait. The soft body can be a chenille wrap, feathers, hairs, fur, or plastics that resemble a fish or other items such as worms, leeches, larva etc.

The fishing jig can be any color. Another common feature is the painting of “eyes” on the head in a variety of colors. Fishing jigs are designed to hold live bait or replicas that mimic local prey fish or large local insects.

A fishing jig is intended to create jerky, vertical motions to attract fish. In some instances, a fishing jig is weighted so that it sinks to the bottom of the lake or water where the fish are then caught. Once at the bottom of the lake, the standard one-headed ball fishing jig generally lays on its side on the bottom of body of water until it is jerked upwards.

There is a need for improving the fishing jig to reduce the chance that the fishing jig tips on its side such that the bait could not be kept above the bottom of body of water.

### SUMMARY

A fishing lure and a method for making the fishing lure are described. The fishing jig includes a plurality of head members, at least a connection region connecting head members adjacent thereto, at least a hook member having a hook shank, a bend connected to a first end of the hook shank and a point adjacent to the bend, and an eyelet. The hook shank is at least partially embedded in the connection region or in a head member. The head members that are adjacent to the connection region are positioned substantially symmetrical relative to the connection region.

Even though the fishing jig is described in relation to the placement of the fishing jig on the bottom of body of water, it is noted that the fishing jig can be used in many ways, for example, swimming, twitching, trolling, floating, etc. and in any type of water in which fishing occurs, for example, ponds, streams, rivers, creeks, marshes, oceans, etc.

### DRAWINGS

FIG. 1 illustrates a side view of the fishing jig as it would sit on the bottom of body of water.

FIG. 2 illustrates a front view of the fishing jig.

FIG. 3 illustrates a back view of the fishing jig.

FIG. 4 illustrates a bottom view of another embodiment the fishing jig.

FIG. 5 illustrates a back view of an angled double hook fishing jig.

FIG. 6 illustrates a back view of a parallel double hook fishing jig.

FIG. 7 illustrates a back view of a stabilizer embedded in the fishing jig.

### DETAILED DESCRIPTION

A fishing lure, specifically a fishing jig, used in the sport of fishing to attract and catch fish is described. The fishing jig includes a plurality of head members, at least a connection region connecting head members adjacent thereto, at least a hook member having a hook shank, a bend connected to a first end of the hook shank and a point adjacent to the bend, and an eyelet. The hook shank is at least partially embedded in the connection region or in a head member. The head members that are adjacent to the connection region are positioned substantially symmetrical relative to the connection region.

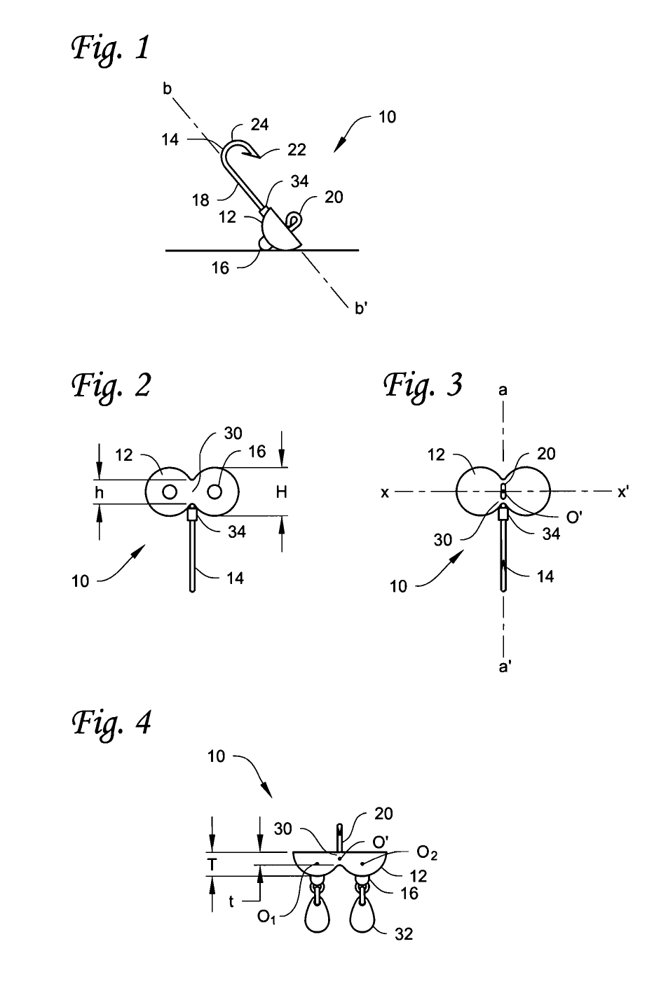

FIG. 1 illustrates an example of a side view of a fishing jig 10 provided with a plurality of head members, at least a connection region 30 connecting head members 12 adjacent thereto, at least a hook member 14 having a hook shank 18, a bend 24 connected to a first end of the hook shank and a point 22 adjacent to the bend 24, and an eyelet 20. The hook shank 18 is at least partially embedded in the connection region 30. The head members 12 that are adjacent to the connection region 30 are positioned substantially symmetrical relative to the connection region 30. FIGS. 2-4 illustrate the front view, back view, and bottom view, respectively, of the fishing jig 10.

With reference to FIGS. 1-4, the fishing jig 10 includes two head members 12 with each head member 12 being in the shape of a half-sphere. Each head member 12 includes a flat surface such that the flat surfaces of the head members 12 are positioned in the same plane, which is considered to be the back of the fishing jig 10. With reference to FIG. 1, when the fishing jig 10 rests on the bottom of body of water, each head member 12 can provide a support surface so that two support surfaces are provided by the head members 12 to better support the fishing jig 10. At the same time, the support of the head members 12 helps the fishing jig 10 to maintain stableness when sitting on the bottom of body of water so that the hook member can be maintained in an upright position and the bait can be kept above the bottom of body of water. In one embodiment, the fishing jig 10 is constructed and weighted such that when reaching the bottom of body of water, the fishing jig 10 can sit on the bottom without tipping.

In one embodiment, an extension 16 is molded, generally centrally, on the rounded portion of each head member 12 so that the extension 16 extends from the surface of the head members 12. The extensions 16 provide additional support for the hook member 14 to stand more upright relative to the bottom of body of water. In addition, the location of the extensions 16 prevents the fishing jig 10 from rolling and aid in the balancing of the fishing jig 10. In one embodiment, the extensions 16 also include attachments 32, for example, spinners, feathers or tassels attached thereto to add additional attractant to the fish.

In one embodiment, each extension 16 is positioned longitudinally perpendicular to the hook shank 18 and allows for the head members 12 of the fishing jig to settle on the bottom of body of water thus allowing the hook shank 18 of the fishing jig to stably stand up, without tipping, on the bottom of body of water such that the hook shank 18 is in an upright position above the bottom of body of water.

The head members 12 can be made of any material that allows for the fishing jig 10 to sink in water. Materials can be, for example, lead, non-lead metals, ceramics, plastics, or any material that can be formed. In an alternative embodiment, the head members 12 can also be floating head members constructed of, for example, closed-cell extruded polystyrene foam or plastics. A fishing jig with a plurality of floating head members can help provide additional flotation for the fishing jig when fishing above the bottom of the body of water is desired. The plurality of head members can exist with or without a collar that stabilizes the hook member 14 and allows for easier application of artificial elements such as plastics or rubber skirts. The collar can exist with or without barb extension to hold artificial elements in place.

Other embodiments contemplated for the shape of the head member 12 include, for example, half-sphere, sphere, rectangular, prism, cube, pyramid, or trapezoid. The head member 12 can also be fish head shaped, cone shaped, bullet shaped, football shaped or pancake shaped. In some embodiments, the head members 12 can even be a capsule, or even a plane or a plane angled to form a “V” shape. In essence, any shape that results in a generally elongated structure that is connected perpendicular to the hook member 14 resulting in the intended use of maintaining the hook member 14 in an upright position above the bottom of body of water can be contemplated. Any of the contemplated shapes can be provided with or without the extension 16. It is to be understood that the plurality of the head members 12 can be substantially identical to each other or different from each other.

The fishing jig 10 also includes at least a connection region 30 connecting head members 12 adjacent thereto. With reference to FIGS. 1-4, the connection region 30 has a height h that is smaller than the height H of the head members 12. Also, the connection region 30 has a thickness t that is smaller than the thickness T of the head members 12. However, it is to be understood that the connection region 30 can be of any shape as long as it connects the head members 12 adjacent thereto. In one embodiment, the connection region 30 can even be in a shape that is substantially identical to the head member 12.

The fishing jig 10 also includes at least a hook member. With reference to FIGS. 1-4, the hook member 14 includes a hook shank 18 having a first end and a second end opposite the first end, a bend 24 at located at the first end of the hook shank 18 and a point 22 adjacent to the bend 24. The hook member 14 can be a single piece of elongated metal, for example, high-carbon steel, steel alloyed with Vanadium, or stainless steel, that is formed to create the hook member 14. With reference to FIGS. 1-4, the second end of the hook shank 18 is molded into the connection region 30 so that the hook shank 18 is partially embedded in the material of the connection region 30. Optionally, the hook member 14 can also include a collar 34 as shown in FIG. 1.

With reference to FIGS. 1-4, the hook shank 18 is parallel to the flat surface of the head members 12 on a planar longitudinal axis b-b′ and the hook shank 18 is perpendicular to the head members 12 on the x-x′ axis. The bend 24 and point 22 are situated generally on an axis a-a′ that dissects the connection region 30. The hook member 14 is embedded such that the point 22 is on the same side of the planar longitudinal axis b-b′ as the flat surface of the head members 12 or at the back of the fishing jig 10.

The two head members 12 are positioned substantially symmetrical relative to the hook shank 18. The geometry center O′ of the connection region 30 and the hook member 14 are positioned in a plane that is perpendicular to a line connecting geometry centers O₁, O₂ of the two head members 12 adjacent to the connection region 30. In an alternative embodiment, the hook shank 18 can be formed in either head member 12 such that it is not centered in the fishing jig 10.

The hook member 14 can be of any size, design, shape, or material and is dependent on the intended purpose of the hook 14 member. The hook member 14 can have a barb or can be barbless. The hook member 14 can be coated or uncoated. The hook member 14 can be provided in various colors.

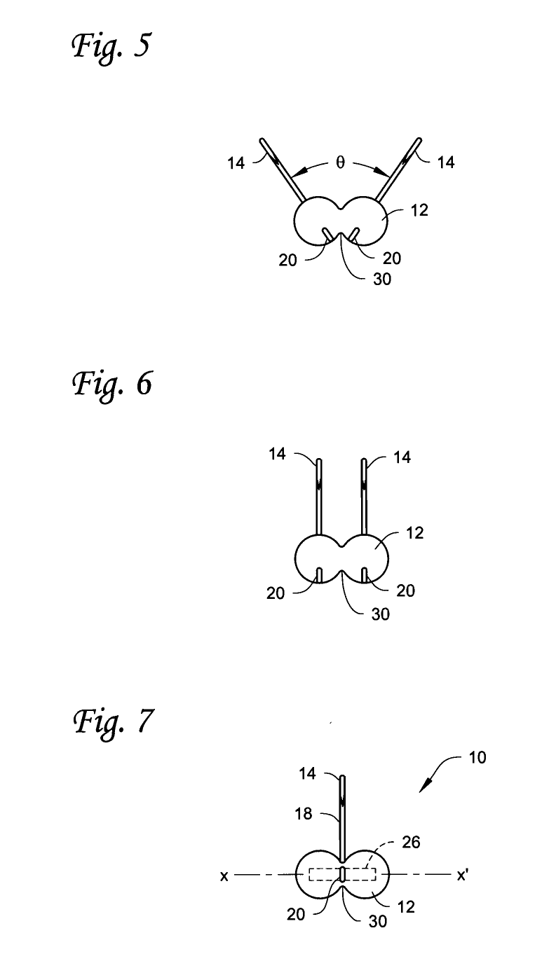

With reference to FIG. 5, two hook members 18 are provided where the hook shank of one hook member 14 is embedded in a head member 12 and the hook shank 18 of the other hook member 14 is embedded in the second head 12. In the embodiment in FIG. 5, the eyelets 20 are in close proximity to each other and the hook members 14 are set at an angle e from each other. In another embodiment, as illustrated in FIG. 6, the hook members 14 can be parallel to each other with the eyelets 20 each protruding from individual head members 12.

The fishing jig 10 also includes an eyelet 20 located adjacent the second end of the hook member 14 and is intended to be connected to the fishing line. With reference to FIGS. 1-4, the eyelet 20 protrudes, in whole or partly, near the surface of the flat surfaces of the head members 12.

It is to be understood that the protrusion of the eyelet 20 from the head members 12 can be in alternate location on the head members 12 and can protrude from the head members 12 at various angles.

In one embodiment, the eyelet 20 and the hook member 14 can be formed integrally. As a result, the locations or angles of the eyelet 20 to some extent depend on the position of the eyelet 20 in relation to the hook shank 18, for example, up turned, down turned, or straight. In the embodiment shown in FIGS. 2 and 3, the eyelet 20 can protrude from the bottom of the head members 12. In another embodiment, as shown in FIG. 1, the eyelet 20 can protrude from the flat surface of the head member 12 closest to the bottom of the head members 12. In another embodiment, the eyelet 20 can protrude from the flat surface of the head members 12 near the connection region 30. In another embodiment, the eyelet 20 can protrude from the flat surface of the head members 12 closest to the top of the head members 12.

In another embodiment, the fishing jig 10 is provided with two or more eyelets 20. The first eyelet 20 is provided for the attachment of the fishing line. The second or more eyelets 20 is provided for attachment of spinners, second hooks, rattles, harnesses, etc.

With reference to FIG. 7, a stabilizer 26 can provided within the head members 12. The stabilizer 26 provides added strength for connecting the head members 12 and also helps maintain stability of the hook member 14. The stabilizer 26 includes a longitudinal apparatus that is embedded within the head members 12, perpendicular to the hook shaft 18 on the x-x′ axis, so as to provide a common support to both head members 12. The stabilizer 26 can be made of any material that would provide sufficient support, for example, metals or plastics. The stabilizer 26 can be, for example, a solid structure or a perforated structure. The stabilizer 26 can be, for example, round, flat, rectangular, triangular, etc. In one embodiment, the stabilizer 26 is connected to the hook shank 18. It is to be understood that the length of the stabilizer 26 can vary but the preferred embodiment is that the length be long enough to extend into each of the head members 12.

It is contemplated that the fishing jig can be equipped with spinners, harnesses, rattles, weedless extensions, multiple hooks, artificial baits, plastic bodies of various configurations, rubber skirts, hair, feathers, or any other accessory that is common within the sport of fishing. It is further contemplated that any color or combination of colors, including fluorescents or glow colors, can be used on the fishing jig and that the color can be applied to the surface of the fishing jig or incorporated within the materials.

The examples and embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A fishing lure, comprising:
a plurality of head members,
at least a connection region connecting head members adjacent thereto,
at least a hook member including a hook shank that has a first end and a second end opposite the first end, a bend connected to the first end of the hook shank and a point adjacent to the bend, and
an eyelet,
wherein the hook shank is at least partially embedded in the connection region or in a head member; and
wherein the head members that are adjacent to the connection region are positioned substantially symmetrical relative to the connection region.

2. The fishing lure of claim 1, wherein each head member includes an extension extending out of an outer surface of the head member.

3. The fishing lure of claim 1, wherein each head member has a shape that is selected from the group consisting of half-sphere, sphere, rectangular, prism, cube, pyramid, trapezoid, fish head shape, cone shape, bullet shape, football shape and pancake shape.

4. The fishing lure of claim 1, wherein two adjacent head members and a connection region between the two head members form a “V” shape with legs of “V” extending perpendicular from the hook shank and away from a direction that the bend of the hook member extends.

5. The fishing lure of claim 1, wherein the connection region has a height that is smaller than a height of at least a head member a thickness that is smaller than a thickness of the head member.

6. The fishing lure of claim 1, wherein the head members are positioned substantially symmetrical relative to the hook shank.

7. The fishing lure of claim 1, wherein the hook member and a geometry center of the connection region are positioned in a plane that is perpendicular to a line connecting geometry centers of at least two head members adjacent to the connection region.

8. A method for making a fishing lure, comprising:
forming a fishing lure that comprises:
a plurality of head members,
at least a connection region connecting head members adjacent thereto,
at least a hook member including a hook shank that has a first end and a second end opposite the first end, a bend connected to the first end of the hook shank and a point adjacent to the bend, and
an eyelet,
wherein the hook shank is at least partially embedded in the connection region or in a head member; and
wherein the head members that are adjacent to the connection region are positioned substantially symmetrical relative to the connection region.
